(19) United States
(12) Patent Application Publication
(10) Pub. No.: US 2015/0023330 A1
(43) Pub. Date: Jan. 22, 2015

(54) Information Transmission From Wireless Access Point

(71) Applicants: John Balian, Littleton, MA (US); Richard S. Davis, Littleton, MA (US); Jung Gun Lee, Palo Alto, CA (US); Sung-Ju Lee, Palo Alto, CA (US)

(72) Inventors: John Balian, Littleton, MA (US); Richard S. Davis, Littleton, MA (US); Jung Gun Lee, Palo Alto, CA (US); Sung-Ju Lee, Palo Alto, CA (US)

(21) Appl. No.: 14/377,919

(22) PCT Filed: Feb. 29, 2012
(86) PCT No.: PCT/US2012/027095

§ 371 Date: Aug. 11, 2014

(51) Int. Cl. H04L 5/00; H04W 74/04

(52) U.S. Cl. CPC H04L 5/0073; H04L 5/005; H04W 74/04
USPC 370/336

(57) ABSTRACT

Embodiments herein relate to transmitting information from wireless access points (WAP) sharing a same frequency channel that is part of an industrial, scientific and medical (ISM) radio band. During a beacon transmit period (BTP), the WAPs transmit a beacon. Then, a first WAP is to collect information from at least one of the plurality of communication devices (CD) associated with the first WAP during a control access period (CAP). Next, the first WAP transmits the collected information during an open access period (OAP).

### BACKGROUND

Wireless networks may operate on unlicensed bands, such as Wi-Fi. Wireless networks that use unlicensed bands may have lower costs than wireless networks that use licensed bands, such as cellular or WiMax networks. For example, deployment, maintenance and system costs of wireless networks using unlicensed bands may be lower than that of those using licensed bands.

However, wireless networks that use unlicensed bands and that are relatively large in size, may not operate effectively. For example, information may be lost and/or transmitted repeatedly in such large wireless networks due to contention and interference, as well as a lack of determinism. Manufacturers, vendors, and/or users are challenged to provide more effective methods for transmitting information over large wireless networks using unlicensed bands.

### BRIEF DESCRIPTION OF THE DRAWINGS

The following detailed description references the drawings, wherein:

FIG. 1 is an example block diagram of a wireless network including a plurality of wireless access points (WAP);

FIG. 2 is an example timing diagram of the WAPs of FIG. 1;

FIG. 3 is an example block diagram of a computing device including instructions for transmitting information over a wireless network; and

FIG. 4 is an example flowchart of a method for transmitting information over a wireless network.

### DETAILED DESCRIPTION

Specific details are given in the following description to provide a thorough understanding of embodiments. However, it will be understood by one of ordinary skill in the art that embodiments may be practiced without these specific details. For example, systems may be shown in block diagrams in order not to obscure embodiments in unnecessary detail. In other instances, well-known processes, structures and techniques may be shown without unnecessary detail in order to avoid obscuring embodiments.

Wireless networks may operate on unlicensed bands and use standards like Wi-Fi, in order to save costs, compared to operating on licensed bands. Also, an bands for licensing and/or exclusive use may not always be available in certain environments. In addition to avoiding licensing fees, wireless networks using unlicensed bands may also have lower deployment, maintenance and system costs.

Nonetheless, interference may become too great between network elements, such as wireless access points (WAP) or client devices CD), using a same frequency channel of the unlicensed band in larger wireless networks. For example, a large wireless network, such as an oil and gas exploration system, may include thousands to millions of CDs, such as sensors, that send information to one or more WAPs over the same frequency channel. The one or more WAPs may forward the information to a central entity, such as a central command center. In this case, reliable delivery of the information may be difficult because of the interference between the CDs and/or WAPs attempting to communicate simultaneously over the same frequency channel. Further, if the CDs and/or WAPs are running on a limited power source, such as a battery, the power source may become drained more quickly, due to retransmissions of information lost to radio frequency (RF) interference. In addition, time may be wasted attempting to receive and/or transmit the information due to the RF interference.

Embodiments may allow for large wireless networks using unlicensed bands to operate with reduced RF interference while also conserving more power and reducing times to transmit or receive information. For example, a plurality of WAPs may share a same frequency channel that is part of an industrial, scientific and medical (ISM) radio band. Each of a plurality of CDs may communicate with one of the WAPs along the same frequency channel.

During a beacon transmit period (BTP), each of a plurality of the WAPs in the wireless network may transmit a beacon. Then, a first WAP of the plurality of WAPs may collect information from at least one of the plurality of CDs associated with first WAP during a control access period (CAP). Next, the first WAP transmits the collected information during an open access period (OAP). A remainder of the WAPs may not access the same frequency channel during the CAP when the first WAP is using the same frequency channel. Further, the above BTP, CAP and OAP may be sequentially repeated for each of the WAPs. Also, the CDs associated with a single WAP may be sequentially polled by the single WAP to collect information during the CAP.

Thus, by limiting ownership of the single, same frequency channel to one WAP at a time and by scheduling polling of the CDs during a time that an associated WAP is in exclusive control of the same frequency channel, embodiments may provide greater fairness, save power and reduce information reception/transmission times. Moreover, by using the ISM radio band, embodiments may be more readily deployed in different environments, such as different parts over the world, because the costs and restrictions inherent in securing a licensed band may not be present.

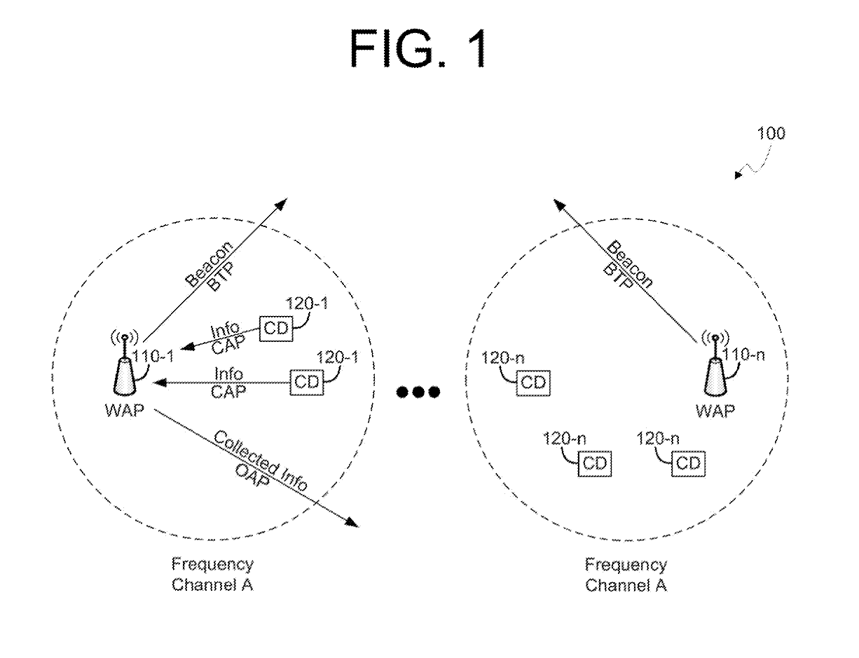

Referring to the drawings, FIG. 1 is an example block diagram a wireless network 100 including a plurality of WAPs 110-1 to 110-n and a plurality of client devices 120-1 to 120-n, where n is a natural number. The wireless network 100 may be any type of network using a transmission system including radio waves from any industrial, scientific and medical (ISM) radio band spectrum. The ISM radio band is generally used for unlicensed operations. Thus, the WAPs may, for example, be wireless LAN devices using one of the following frequency channels: 2450 MHz band (Bluetooth), 5800 MHz band (HIPERLAN), 2450 and 5800 MHz bands (IEEE 802.11/WiFi) and/or 915 and 2450 MHz bands (IEEE 802.15.4/ZigBee).

FIG. 1 shows a plurality of WAPs 110-1 to 110-n where at least two of the WAPs are shown to share the same frequency channel A that is part of the ISM band, such as one of the frequency channels listed above. The term frequency channel may refer to a specific, pair and/or band of frequencies. For example, the frequency channel 2.450 Gigahertz (GHz) may refer to a center frequency of 2.450 GHz and a frequency range of 2.400 GHz to 2.500 GHz.

The WAPs 110-1 to 110-n may be any type of device that allows information collected from the CDs 120-1 to 120-n to be relayed to a remainder of the wireless network 100, such as a router, a switch, a gateway, a server, a command center and the like. The CDs 120-1 to 120-n may include any type of device capable of measuring, collecting, storing and/or transmitting information to one of the WAPs 110-1 to 110-n, such as a sensor, a transmitter, and the like. For example, an embodiment of the wireless network 100 may include about 100 WAPs 110-1 to 110-100 and about 100 CDs 120 associated each WAP 110. Each WAP 110 and its associated one or more CDs 120 may be referred to as a cell. For example, the first WAP 110-1 and the first devices 120-1 may form a fiat cell while the nth WAP 110-n and the nth devices 120-n may form an nth cell.

The WAPs 110-1 to 110-n may include, for example, a hardware device including electronic circuitry for implementing the functionality described below, such as control logic and/or memory. In addition or as an alternative, the WAPs 110-1 to 110-n may be implemented as a series of instructions encoded on a machine-readable storage medium and executable by a processor.

As noted above, the plurality of WAPs 110-1 to 110-n share the frequency channel A, which is part of the ISM band. The frequency channel A is used, for example by the plurality of WAPs 110-1 to 110-n to communicate with the plurality of CDs 120-1 to 120-n and/or to each other. Each of the CDs 120-1 to 120-n communicates with one of the WAPs 110-1 to 110-n along the same frequency channel A. For example, the first CDs 110-1 communicate with first WAP 110-1 using the frequency channel A and the nth CDs 120-n communicate with the nth WAP 110-n using the frequency channel A.

As shown in FIG. 1, each of the WAPs 110-1 to 110-n transmits a beacon during a beacon transmit period (BTP) on the frequency channel A. The beacon may be a continuous or periodic radio signal with limited information content, such as an SSID, a channel number and security protocols such as WEP (Wired Equivalent Privacy) or WPA (Wi-Fi Protected Access). The beacon may be transmitted at regular intervals by the WAPs 110-1 to 110-n.

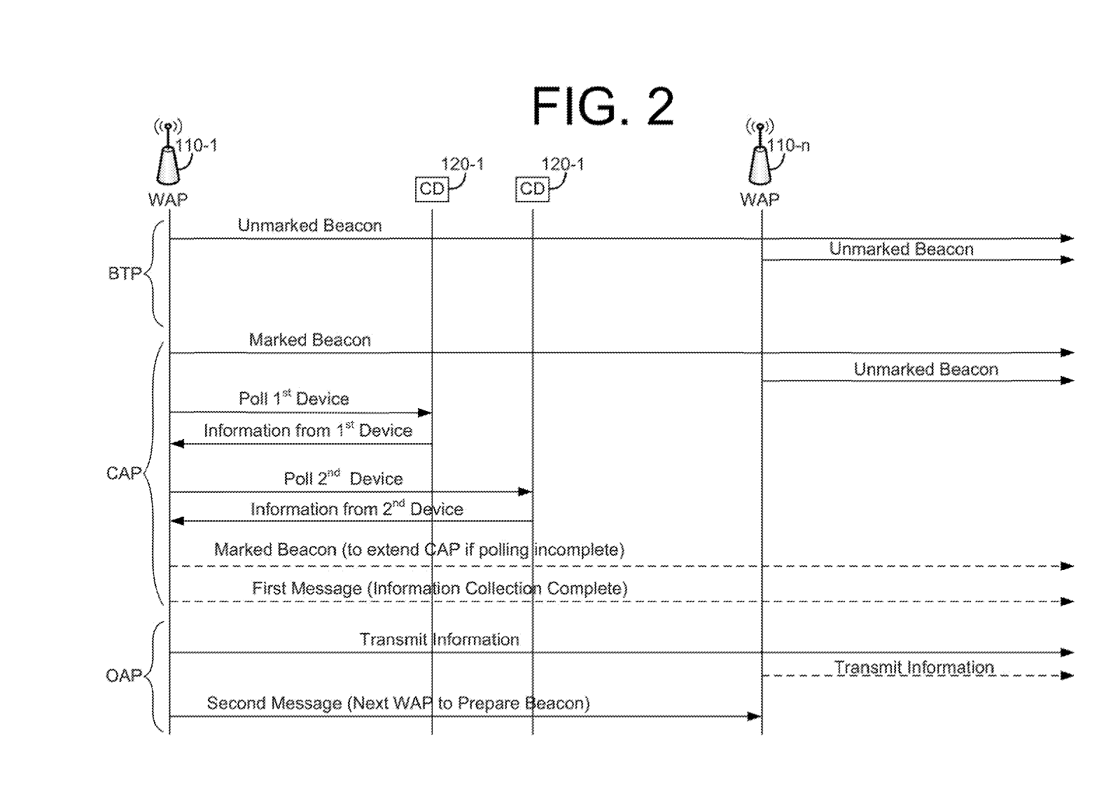

Next, a first WAP 110-1 of the plurality of WAPs 110-1 to 110-n that transmitted the beacons is to collect information from at least one of the plurality of CDs 120-1 associated with the first WAP 110-1 during a control access period (CAP). Lastly, the first WAP 110-1 transmits the collected information during an open access period (OAP). The BTP, CAP and OAP will be described in greater detail with respect to FIG. 2.

FIG. 2 is an example timing diagram of the WAPs 110 of FIG. 1. While FIG. 2 only shows the timing diagram with respect to two WAPs 110-1 and 110-n, the BTP, CAP and OAP relay repeat for each of the WAPs 110-1 to 110-n. A single cycle is completed when all of the WAPs 110-1 to 110-n have received an opportunity to use the frequency channel A. For example, a length of the BTP may be 20 milliseconds (ms), the CAP may be 60 ms and the OAP may be 70 ms. Yet the entire cycle may be 20 seconds. Thus, each of the BTP, CAP and OAP may repeat every 150 ms until all of the WAPs 110-1 to 110-n have received their turn to use the frequency channel A. For instance, if there are 100 WAPs 110-1 to 110-100, it may take 15 seconds (150 ms×100) for all of the WAPs 110-1 to 110-100 to use the frequency channel A. Thus, the cycle may be 15 seconds or the cycle may remain longer, such as 20 seconds, with a last 5 seconds of cycle being open to other uses of the frequency channel A. Once the cycle ends, a new cycle starts, with each cycle restarting with the first WAP 110-1.

As shown in FIG. 2, the first WAP 110 and the nth WAP 110-n do not transmit the beacon simultaneously or at a same time during the BTP. Instead, each of the WAPs 110-1 to 110-n transmits the beacon sequentially during the BTP so as to avoid or reduce radio frequency interference from beacons of different WAPs 110 colliding. The sequence for transmitting the unmarked beacons may be determined automatically, such as by an algorithm, or manually beforehand, such as by a user, an administrator, or a manufacturer. Sequencing the transmission of beacons may not be necessary between WAPs 110 that are geographically too distance to hear each other's beacons.

In one embodiment, each of the WAPs 110 may be assigned an order number beforehand, such as by a user, administrator, or manufacturer. The order may be determined according to any method, such as a timing sequence, a location of the WAPs 110, or distances of the WAPs 110 from a central point. Thus, in FIG. 2, the first WAP 110-1, may be assigned a first order number while the nth WAP 110-n may be assigned nth order number. Then, during the BTP, each of the WAPs 110-1 to 110-n may listen for unmarked and/or marked beacons from nearby WAPs 110. As noted above, the beacon may include information identifying the WAP 110 that transmitted the beacon.

For instance, during a first iteration of the BTP, all the WAPs 110-1 to 110-n may transmit unmarked beacons. The first WAP 110-1 may determine that its turn to use the frequency channel A is next if it only hears unmarked beacons and has not previously heard any marked beacons for a first cycle. However, for subsequent cycles, the first WAP 110-1 may only determine that its turn to use the frequency channel A is next if it hears a marked beacon from the nth WAP 110-n during a last iteration of the CAP. Similarly, a remainder of the WAPs 110-2 to 110-n (where n greater than 2) may determine that their turn to use the frequency channel A is next only if they hear marked beacon from the previous WAP 110-1 to 110-(n−1) during a previous iteration of the CAP. For example, the fifth WAP 110-5 would determine that its turn to use the frequency channel A is next if it hears the marked beacon of the fourth WAP 1104 during the latest iteration of the CAP. The current WAP 110 controlling the frequency channel A may need to be geographically close enough to at least the next WAP 110 receiving control of the frequency channel A such that the next WAP 110 may hear marked beacon of the current WAP 110.

In another embodiment (not shown), the order for transferring control of the frequency channel A may be determined centrally instead of in a distributed manner. For example, a higher layer or powered controlling WAP (not shown) may detect all the beacons and determine order in which the all the WAPs 110-1 to 110-n are to share the frequency channel A, such as based on MAC addresses of the WAPs and the like. In this case, the WAPs 110-1 to 110-n may require enough transmission power for their beacons to reach the controlling WAP and the controlling WAP may require enough transmission power to reach all the WAPs 110-1 to 110-n. In addition, the controlling WAP may supplement the above described distributed system, such as by helping to pass control of the frequency channel A when one of the WAPs 110 refuses to relinquish control of the frequency channel A.

Next, during the CAP, the WAP 110 that currently is determined to have access to the frequency channel A transmits a marked beacon. The beacon may be marked, for example, by setting a flag or bit. In one embodiment, a Point coordination function (PCF) of the IEEE 802.11 standard may be used, such that the marked beacon indicates a Contention Free Period (CFP) while an unmarked period indicates a Contention Period (CP).

In FIG. 2, the first WAP 110-1 transmits the marked beacon while a remainder of the WAPS 110, such as the nth WAP 110-n, transmit the unmarked beacon. The marked beacon may indicate to the first client devices 120-1 to prepare for communication with the first WAP 110-1 and that the first WAP 110-1 is in exclusive control of the frequency channel A. The unmarked beacon may indicate to a remainder of the CDs, such as the nth client device 120-n, to not prepare for any immediate communication with their associated WAP 1 The unmarked beacon may also indicate that the remainder of the plurality of WAPs are not in control of the frequency channel A to the remainder of the plurality of CDs 120-2 to 120-n (where n is greater than 2).

Next, the first WAP 110-1 may collect information from the one or more first client devices 120-1 during the CAP. If there is more than one first client device 120-1, the first WAP 110-1 may sequentially poll the first client devices 120-1, such as by transmitting Contention-Free-Poll (CF-Poll) packets. In response to being polled, the first devices 120-1 may transmit information to the first WAP-1. For example, the first devices 120-1 may transmit information collected by sensors, such as pressure and light data. A remainder of the WAPs 110, such as the nth WAP 110-n, do not communicate with any of the plurality of CDs 120-1 to 120-n during this CAP.

The first CDs 120-1 associated with the first WAP 110-1 at least one of awake and remain awake in response to receiving the marked beacon and/or being polled. During a remainder of the time, the first CDs 120-1 may remain in a low power state, such as a sleep, hibernate or off state, to conserve energy and/or increase a lifespan of the first CDs 120-1. For example, if the first CDs 120-1 are battery powered, staying in the lower power state may significantly increase a time before the battery is recharged and/or replaced. The remaining CDs 120-2 to 120-n associated with the remainder of the plurality of WAPs 110-2 to 120-n at least one of remain in and enter the low power state it response to receiving the unmarked beacon. Further, the remaining CDs 120-2 to 120-n may react similarly to the first CD 120-1 when receiving marked beacons.

In one embodiment, the first WAP 110-1 may transmit a first message, such as a CF-End Frame or token, during the CAP to at least one of the plurality of WAPs 120-2 to 120-n to indicate that the first WAP 120-1 has completed collecting information from the first CDs 120-1 and to indicate an end of the CAP, if the first WAP 110-1 completes collecting the information from all the first devices 110-1 within the CAP. Alternatively, the first WAP 110-1 may not transmit the first message when the WAP 110-1 completes collecting the information from all the first devices 110-1 before the CAP ends. In this case, the first WAP 110-1 may simply wait for the CAP end, instead of prematurely shortening the CAP.

However, if the first WAP 110-1 anticipates not completing collection of the information from the first CDs 120-1 during the CAP, the first WAP 110-1 may extend the CAP to complete collecting the information from all the first devices 110-1. For example, at a threshold time period before the CAP is to end, the first WAP 110-1 may transmit or continue to transmit the marked beacon to extend a time interval of the CAP.

After the CAP is over, first WAP 110-1 transmits the collected information during OAP. The first WAP 110-1 may, for example, transmit the collected information to another of the WAPs 110-2 to 110-n and/or a higher level WAP or network element, such as a hub, router or gateway. The first WAP 110-1 may also transmit a second message during the OAP to the second WAP 110-2. The second message is to indicate that the second WAP 110-2 is to have exclusive control of the frequency channel A during a subsequent iteration of the CAP. Alternatively, the first WAP 110-1 may not the second message. Instead, the second WAP 110-2 may determine that is to have exclusive control of the frequency channel A during a subsequent iteration of the CAP upon hearing the marked beacon of the first WAP 110-1. The second WAP 110-2 may prepare a marked beacon to be transmitted during the subsequent iteration of the CAP, in response to learning it will next have exclusive control of the frequency channel A.

The OAP may be a time period where more than one of the WAPs 110-1 to 110-n may communicate using the frequency channel A. In addition, a new CD 120 being added to the network may also communicate using the frequency channel A during the OAP to indicate its presence to its associated WAP 110. However, non-new CDs 120 may not generally transmit information using the frequency channel A during the OAP. Due to simultaneous use of the frequency channel A by the WAPs 110 and/or new CDs 120, there may be interference or contention during the OAP. As a result, contention mechanisms may be used during this time period, such as a Distributed Coordination Function (DCF) of the 802.11 standard.

The BTP, CAP, and OAP sequentially iterate until all of the plurality of the WAPs 110-1 to 110-n have exclusively controlled the frequency channel A. As explained above, the transitions between the BTP, CAP and OAP may be determined asynchronously by at least one of the WAPs 110-1 to 110-n signaling an end or beginning of at least one of the BTP, CAP and OAP. Alternatively or in addition to, transitions between the BTP, CAP, and OAP may be timed to occur synchronously, such as by using a global timer. As a result, less signals may be transmitted by the WAPs 110-1 to 110-n between transitions of the BTP, CAP and OAP.

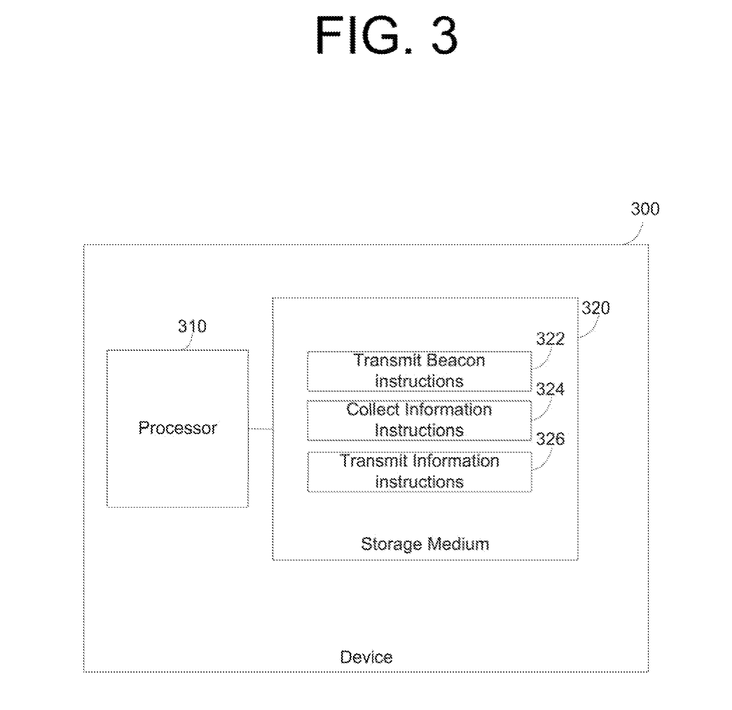

FIG. 3 is an example block diagram of a computing device 300 including instructions for transmitting information over a wireless network. In the embodiment of FIG. 3, the computing device 300 includes a processor 310 and a machine-readable storage medium 320. The machine-readable storage medium 320 further includes instructions 322, 324 and 326 for transmitting information over the wireless network.

The computing device 300 may be, for example, a router, a switch, a gateway, a server, a command center or any other type of user device capable of executing the instructions 322, 324 and 326. In certain examples, the computing device 300 may included or be connected to additional components such as memories, sensors, displays, wireless access points (WAP), client devices (CD), etc.

The processor 310 may be, at least one central processing unit (CPU), at least one semiconductor-based microprocessor, at least one graphics processing unit (GPU), other hardware devices suitable for retrieval and execution of instructions stored in the machine-readable storage medium 320, or combinations thereof. The processor 310 may fetch, decode, and execute instructions 322, 324 and 326 to implement for transmitting information over the wireless network. As an alternative or in addition to retrieving and executing instructions, the processor 310 may include at least one integrated circuit (IC), other control logic, other electronic circuits, or combinations thereof that include a number of electronic components for performing the functionality of instructions 322, 324 and 326.

The machine-readable storage medium 320 may be any electronic, magnetic, optical, or other physical storage device that contains or stores executable instructions. Thus, the machine-readable storage medium 320 may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium 320 can be non-transitory. As described in detail below, machine-readable storage medium 320 may be encoded with a series of executable instructions for transmitting information over the wireless network.

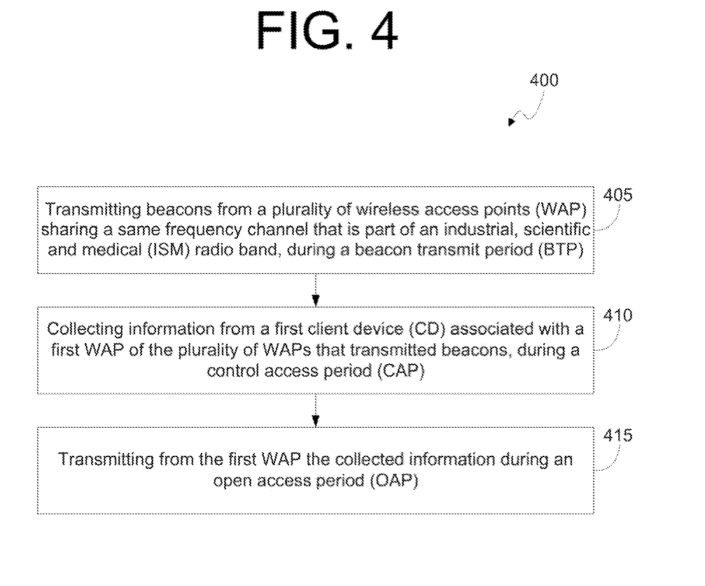

Moreover, instructions 322, 324 and 326 when executed by a processor (e.g., via one processing element or multiple processing elements of the processor) can cause the processor to perform processes, such as, the process of FIG. 4. For example, the transmit beacon instructions 322 may be executed by the processor 310 to transmit a beacon from a first WAP (not shown) over a frequency channel usable by a second WAP (not shown), the frequency channel being part of an ISM radio band, during a BTP.

The collect information instructions 324 may be executed by the processor 310 to collect information from a first CD (not shown) associated with the first WAP, during a CAP, if the first WAP is determined to have exclusive control during the CAP. The transmit information instructions 326 may be executed by the processor 310 to transmit from the first WAP the collected information during an OAP.

The machine-readable storage medium 420 may also include instructions (not shown) to indicate to the second WAP that the second WAP is to receive exclusive control of the same frequency channel after the first WAP collects the information from the first CD. The first WAP collects the information from the first CD during a first iteration of the CAP and the second WAP collects information from a second CD during a second iteration of the CAP.

FIG. 4 is an example flowchart of a method 400 for transmitting information over a wireless network. Although execution of the method 400 is described below with reference to the wireless network 100, other suitable components for execution of the method 400 can be utilized. Additionally, the components for executing the method 400 may be spread among multiple devices. The method 400 may be implemented in the form of executable instructions stored on a machine-readable storage medium, such as storage medium 320, and/or in the form of electronic circuitry.

At block 405, the plurality of WAPs 110-1 to 110-n of the wireless network 100 transmit beacons over a same shared frequency channel that is part of the ISM radio band, during the BTP. Next, at block 410, the first WAP 110-1 collects information from the first CD 120-1 associated with the first WAP 110-1, during the CAP. A remainder of the plurality of WAPs 110-2 to 110-n (where n is greater than 2) do not collect information during the CAP. Also, a second CD, such as the nth CD 120-n, not associated with the first WAP 110-1 at least one of remains in and enters the lower power state during the CAP. Then, at block 415, the first WAP 110-1 transmits the collected information during the OAP. While at least some of the figures have been described to have at least three WAPs 110 (e.g. n greater than or equal to 3), embodiments may also include more or less than three WAPs 110.

According to the foregoing, embodiments provide a method and/or device for allowing WAPs sharing a same unlicensed frequency channel in a large wireless network to operate with reduced RF interference while also conserving more energy of CDs and reducing times to transmit or receive information. For example, embodiments may limit ownership of the single, same frequency channel to one WAP at a time and schedule polling of the CDs during this time of exclusive control of the same frequency channel, this providing greater fairness, saving power and reducing instances of retransmission

We claim:

1. A wireless network, comprising:
a plurality of wireless access points (WAP) sharing a same frequency channel that is part of an industrial, scientific and medical (ISM) radio band; and
a plurality of client devices (CD), each of the CDs communicating with one of the WAPs along the same frequency channel, wherein
each of the WAPs is to transmit a beacon during a beacon transmit period (BTP),
a first WAP of the plurality of WAPs that transmitted the beacons is to collect information from at least one of the plurality of CDs associated with the first WAP during a control access period (CAP);
the first WAP transmits the collected information during open access period (OAP).

2. The wireless network of claim 1, wherein,
each of the WAPs transmit the beacon sequentially during the BTP such that none of the WAPs transmit the beacon simultaneously, and
one of the WAPs is selected as the first WAP based on at least one of the transmitted beacons, MAC addresses of the WAPs, distances of the WAPs from a central point and a timing sequence.

3. The wireless network of claim 1, wherein a remainder of the plurality of WAPs are to not collect information from any of the plurality of CDs during the CAP.

4. The wireless network of claim 1, wherein,
the first WAP collects information from more than one of the plurality of CDs during the CAP, and
the first WAP sequentially polls the more than one of the plurality of CDs during the CAP.

5. The wireless network of claim 1, wherein,
the first WAP marks the beacon transmitted at intervals during the CAP to indicate to the at least one CD associated with the first WAP that the first WAP is in exclusive control of the same frequency channel, and
the at least one CD associated with the first WAP at least one of awakes and remains awake in response to receiving the marked beacon.

6. The wireless network of claim 5, wherein,
a remainder of the plurality of WAPs do not mark the beacon transmitted at intervals during the CAP,
the unmarked beacons indicate that the remainder of the plurality of WAPs are not in control of the same frequency channel to a remainder of the plurality of CDs associated with the remainder of the plurality of WAPs, and
the CDs associated with the remainder of the plurality of WAPs at least one of remain in and enter a low power state in response to receiving the unmarked beacon.

7. The wireless network of claim 6, wherein the first WAP transmits a first message during the CAP to at least one of the plurality of WAPs to indicate that the first WAP has completed collecting information from the at least one CD associated with the first WAP and to indicate an end of the CAP, if the first WAP completes collecting the information within the CAP.

8. The wireless network of claim 7, the first WAP continues to transmit the marked beacon past a threshold time period to extend a time interval of the CAP, if the first WAP does not complete collecting the information during the threshold time period.

9. The wireless network of claim 7, wherein,
the first WAP transmits a second message during the OAP to a second WAP of the plurality of WAPs,
the second message is to indicate that the second WAP is to have exclusive control of the same frequency channel during a subsequent iteration of the CAP, and
the BTP, CAP, and OAP sequentially iterate until all of the plurality of the WAPs have exclusively controlled the same frequency channel.

10. The wireless network of claim 9, wherein,
at least one of the plurality of WAPs and a new CD added to the network transmits information during the OAP, and
the second WAP is to prepare a marked beacon to be transmitted during the subsequent iteration of the CAP.

11. The wireless network of claim 1, further comprising:
a plurality of cells, each of the cells including one of the WAPs and at least one of the plurality of CDs, wherein
each of the CDs is a sensor to measure and store information, and
the CDs and WAPs communicate using an IEEE 802.11 communication standard.

12. A method, comprising:
transmitting beacons from a plurality of wireless access points (WAP) sharing a same frequency channel that is part of an industrial, scientific and medical (ISM) radio band, during a beacon transmit period (BTP);
collecting information from a first client device (CD) associated with a first WAP of the plurality of WAPs that transmitted beacons, during a control access period (CAP); and
transmitting from the first WAP the collected information during an open access period (OAP).

13. The method of claim 12, wherein:
a remainder of the plurality of WAPs do not collect information during the CAP, and
a second CD not associated with the first WAP at least one of remains in and enters a lower power state during the CAP.

14. A non-transitory computer-readable storage medium storing instructions that, if executed by a processor of a device, cause the processor to:
transmit a beacon from a first wireless access point (WAP) over a frequency channel usable by a second WAP, the frequency channel being part of an industrial, scientific and medical (ISM) radio band, during a beacon transmit period (BTP);
collect information from a first client device (CD) associated with the first WAP, during a control access period (CAP), if the first WAP is determined to have exclusive control during the CAP; and
transmit from the first WAP the collected information during an open access period (OAP).

15. The non-transitory computer-readable storage medium of claim 14, further comprising instructions that, if executed by the processor, cause the processor to:
indicate to the second WAP that the second WAP is to receive exclusive control of the frequency channel after the first WAP collects the information from the first CD, wherein
the first WAP collects the information from the first CD during a first iteration of the CAP and the second WAP collects information from a second CD during a second iteration of the CAP.
